(19) United States
(12) Patent Application Publication
(10) Pub. No.: US 2017/0331940 A1
(43) Pub. Date: Nov. 16, 2017

(54) Systems and Methods to Archive and Organize Electronic Messages

(71) Applicant: GoKeeps, Inc, Los Angeles, CA (US)

(72) Inventor: Jennifer Marqot Simchowitz, Los Angeles, CA (US)

(21) Appl. No.: 15/593,195

(22) Filed: May 11, 2017

Related U.S. Application Data
(60) Provisional application No. 62/335,328, filed on May 12, 2016.

(51) Int. Cl. H04M 1/725; G06F 17/30; G06F 3/0482; G06F 3/0483; H04W 4/12

(52) U.S. Cl. CPC H04M 1/72552; H04W 4/12; G06F 17/30312; G06F 3/0482; G06F 3/0483; G06F 17/30309

(57) ABSTRACT

Systems and methods to: provide, on a mobile device of a user, a mobile application; retrieve, from a plurality of different servers using a plurality of different communication protocols, messages in different accounts of the user; index the messages for searching; provide, via the mobile application, a search interface for the messages; receive, in the search interface, a search request; identify, from the messages indexed for searching, a subset of messages in response to the search request; present a list of messages in the subset to the user via the mobile application; create a package in response to the user selecting one or more messages from the list, the package including the one or more selected messages; and archive the package.

### RELATED APPLICATIONS

The present application claims the benefit of the filing date of Prov. U.S. Pat. App. Ser. No. 62/335,328, filed May 12, 2016 and entitled “Systems and Methods to Archive and Organize Electronic Messages”, the entire disclosure of which application is hereby incorporated herein by reference.

### FIELD OF THE TECHNOLOGY

At least some embodiments disclosed herein relate to the processing of electronic messages in general and, more specifically but not limited to, the search of messages and the packaging of messages for future references, such as instant messages and text messages.

### BACKGROUND

Computer-based search techniques have greatly improved access to information. For example, web search engines may use web crawlers to automatically discover and visit web sites; and the web pages of the visited web sites are indexed for searches such that users of the search engines can easily locate websites of interest.

Some techniques have been developed for the search of emails. For example, U.S. Pat. No. 9,032,031, entitled “Apparatus, Method and Computer Program Product for Processing Email, and Apparatus for Searching Email”, discloses a technique to search for a search target email stored in an email storage unit.

Some techniques have been developed for searches in instant messaging systems. For example, U.S. Pat. No. 7,490,076, entitled “Method for Searching across Instant Message Systems and Interconnecting Server”, discloses an interconnecting server coupled between instant messaging systems that use different communication protocols to facilitate seamless searches across the instant messaging systems, for information such as a user, a chat room, a member in a chat room, or a chat history of a chat room, etc.

Some techniques have been developed to provide a friendly user interface in message applications. For example, U.S. Pat. No. 7,590,699, entitled “Instant Messaging with Built-In Search”, discloses a search interface integrated in an instant messaging application that allows the search results obtained during a search performed in an instant messaging session to be automatically communicated to the participants of the instant messaging session.

The disclosures of the above discussed patent documents are hereby incorporated herein by reference.

### BRIEF DESCRIPTION OF THE DRAWINGS

The embodiments are illustrated by way of example and not limitation in the figures of the accompanying drawings in which like references indicate similar elements.

FIG. 1 shows a system to organize electronic messages for archival, packaging, and printing according to one embodiment.

FIG. 2 shows a method to generate a package of selected electronic messages according to one embodiment.

FIGS. 3-44 illustrate examples of user interfaces to operate a mobile application according to one embodiment.

FIG. 45 illustrates a data processing system according to one embodiment.

### DETAILED DESCRIPTION

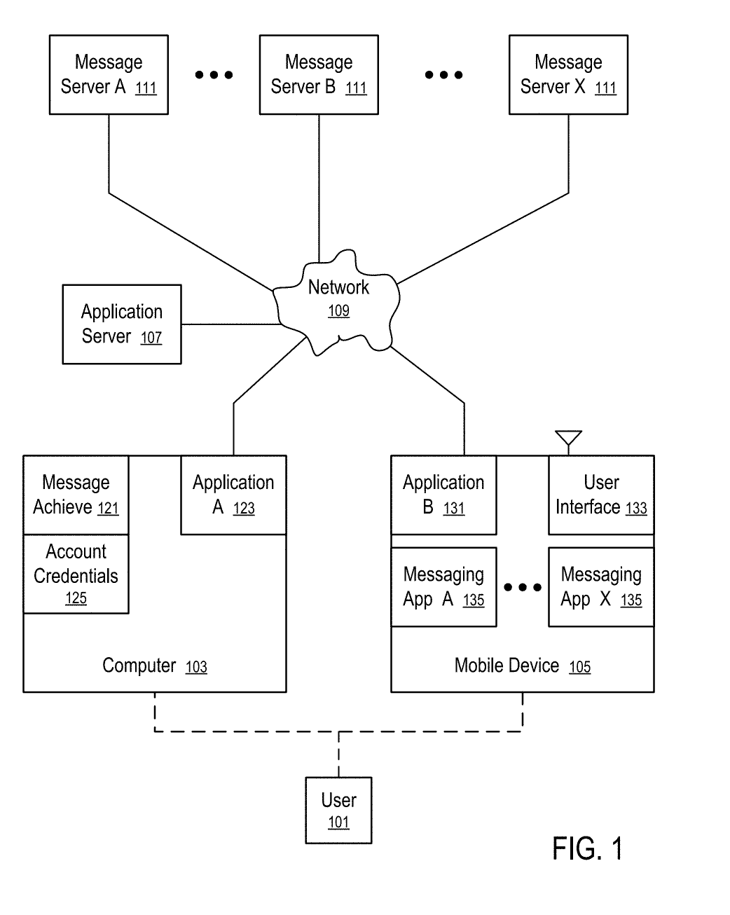

FIG. 1 shows a system to organize electronic messages for archival, packaging, and printing according to one embodiment.

In FIG. 1, a mobile device (105) is configured to have messaging applications (135) to receive, over a communication network (109) electronic messages from different types of message servers (111), such as emails, instant messages, text messages delivered via short message service, messages delivered via Extensible Messaging and Presence Protocol (XMPP), and messages delivered via proprietary protocols.

Some of the message servers (111) do not store a copy of the message once the message is delivered to the user (101) (e.g., via one of the messaging applications (135)).

Some of the message servers (111) limit the storage of message to a predetermined period of time window; and messages older than the time window are purged from such servers.

Since the mobile device (105) has a very limited storage capacity, some of the messaging applications (135) limit the storage of the messages on the mobile device to a predetermined period of time window and/or a predetermined amount of message data.

The system illustrated in FIG. 1 provides a mobile application (131) on the mobile device (105) of a user, an application (123) on a computer (103) of the user (101) and/or an application server (107) to provide new functionalities to store and/or organize the messages in the accounts of the user (101). The system allows the user to search the messages, even though some of the messages are not stored in the message servers (111) and/or the mobile device (105), and combine selected messages into packages for archival and/or printing.

For example, in one embodiment, the application (131) configured on the mobile device (105) is configured to be in communication with the messaging applications (135) to retrieve the messages received in the messaging applications (135) and provide the messages to the application (123) installed in the computer (103) of the user (101) and/or the application server (107) when the connection to the network (109) is available. The collected messages can be indexed and searched using a user interface (133) on the mobile device (105) via the application (131) running on the mobile device (105). The user interface (133) controlled by the mobile application (131) can be used by the user (101) to perform a search of the messages stored together in the computer (103) and/or the application server (107), generate a package of messages selected from the search results, and achieve the package on the application server (107) and/or the computer (103) for later retrieval beyond the time periods for message expiration on the message servers (111) and/or the mobile device (105).

In some embodiments, the collected messages are at least in part retrieved by the application (123) configured in the computer (103) (e.g., a personal computer, a desktop computer, a laptop computer) using the account credentials (125) of the user (101) associated with the accounts of the user (101) on the message servers (111). Thus, the communication bandwidth and/or usage of the mobile device (105) can be reduced.

In some embodiments, the collected messages are at least in part retrieved by the application server (107) on behalf of the user (101) using the account credentials (125) of the user (101) associated with the accounts of the user (101) on the message servers (111).

In general, the collected messages can be stored on the mobile device (105) under the control of the mobile application (131), on the computer (103) under the control of the application (123), and/or on the application server (107). For example, the computer application (123) is configured to copy the messages from the mobile applications (131/135) using a connection between the computer (103) and the mobile device (105), and then provide the messages to the server (107) in an account of the user of the mobile device (105) and the computer (103). For some of the messaging services, the computer application (123) is not necessary to make a copy of the messages; and instead, the mobile application (131/135) can connect directly to their message servers (111) via OAuth and/or APIs. For some of the messaging services, the application server (107) can retrieve the messages directly from respective message servers (111) via OAuth and/or APIs. Thus, the application server (107) can store the collected messages to facilitate searches. For example, in response to a search query of messages received in the user interface (133) on the mobile device (105), the mobile application (131) transmits the query in real time to the application server (107), which performs the search and provides the results to the mobile application (131) for presentation on the user interface (133).

The mobile application (131), the application (123), and the application server (107) may cooperate with each other to store the collected messages. For example, the computer (103) and the application server (107) may not store the messages that are currently in the mobile device (105). When certain messages are about to expire in the messaging applications (135), a copy of the expiring messages are stored under the control of the mobile application (131), transmitted to the application (103) in the computer (103) and/or the application server (107) for storage. Alternatively, the application (123) and/or the application server (107) are configured to retrieve the expiring messages from the respective messages server (111) if such messages are still available in the message servers (111).

In one embodiment, the collected messages are stored temporarily for a time period to facilitate search. After the time period, the collected messages not selected for archival can be purged. Thus, the user (101) has the option to allow the messages to expire and be purged after the time period, and the option to search and package messages for archival of selected messages for a time period longer than the time period for automatic expiration.

In one embodiment, the message achieve (121) is stored on the computer (103) under the control of the application (123). Alternatively or in combination, the message achieve (121) is stored in the application server (107).

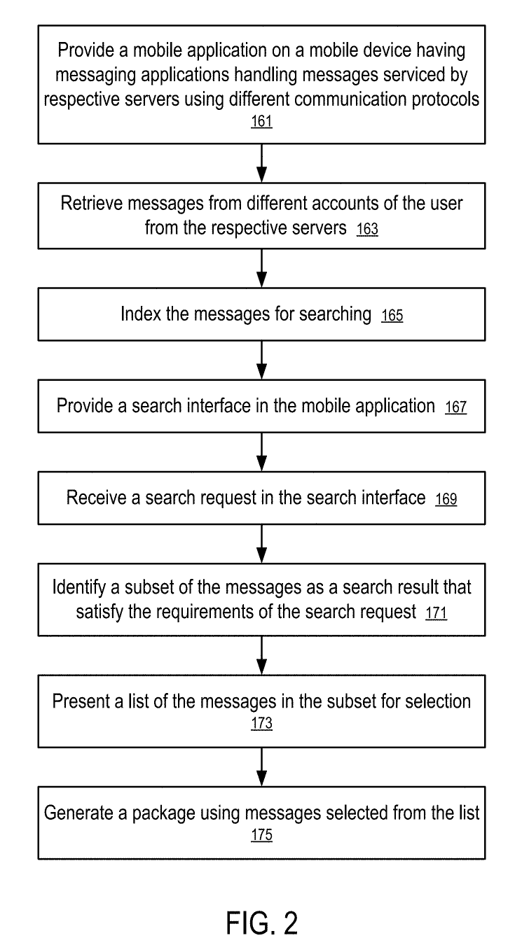

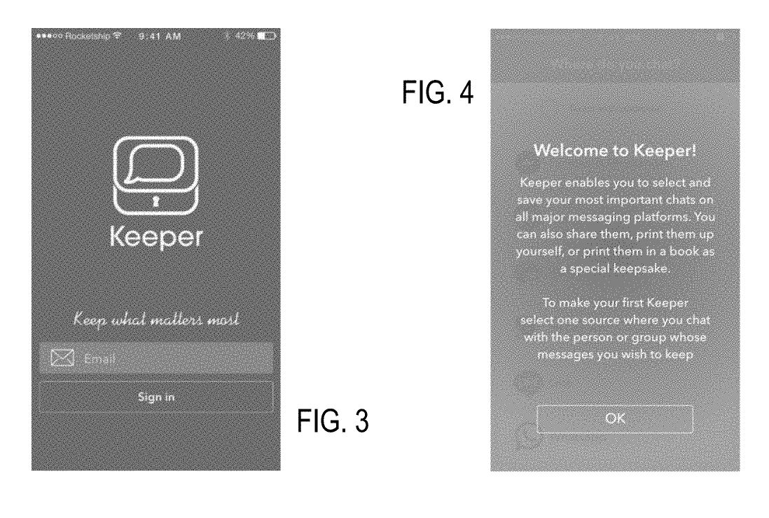

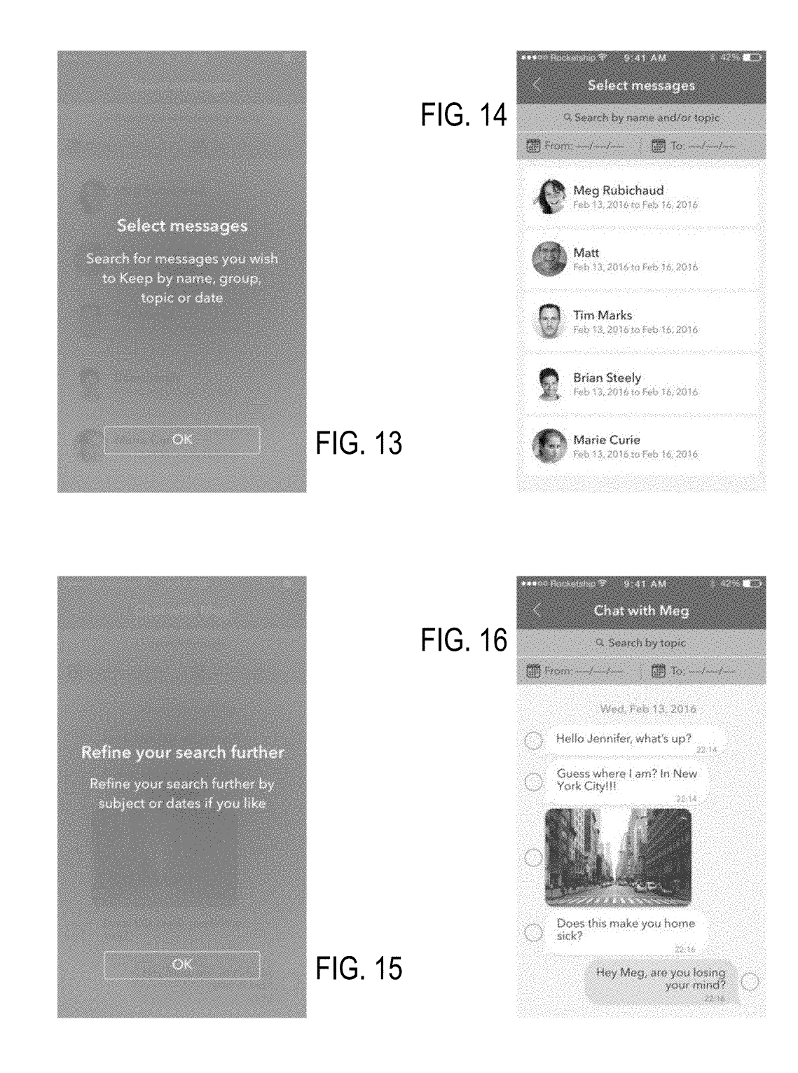

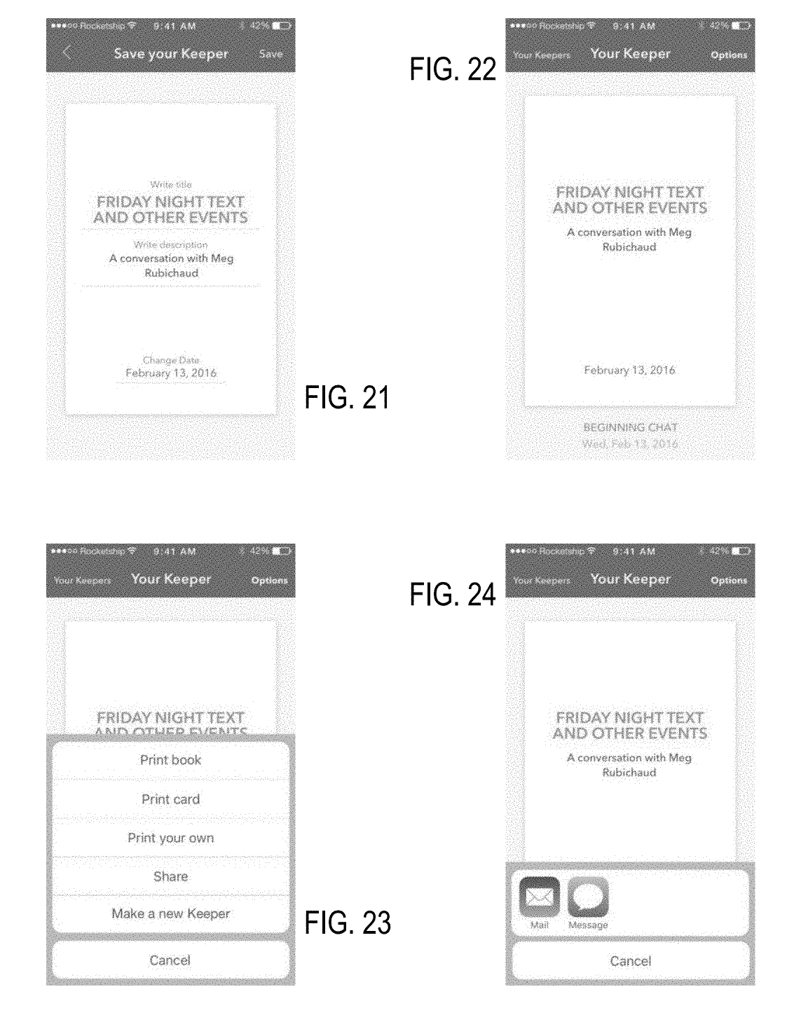

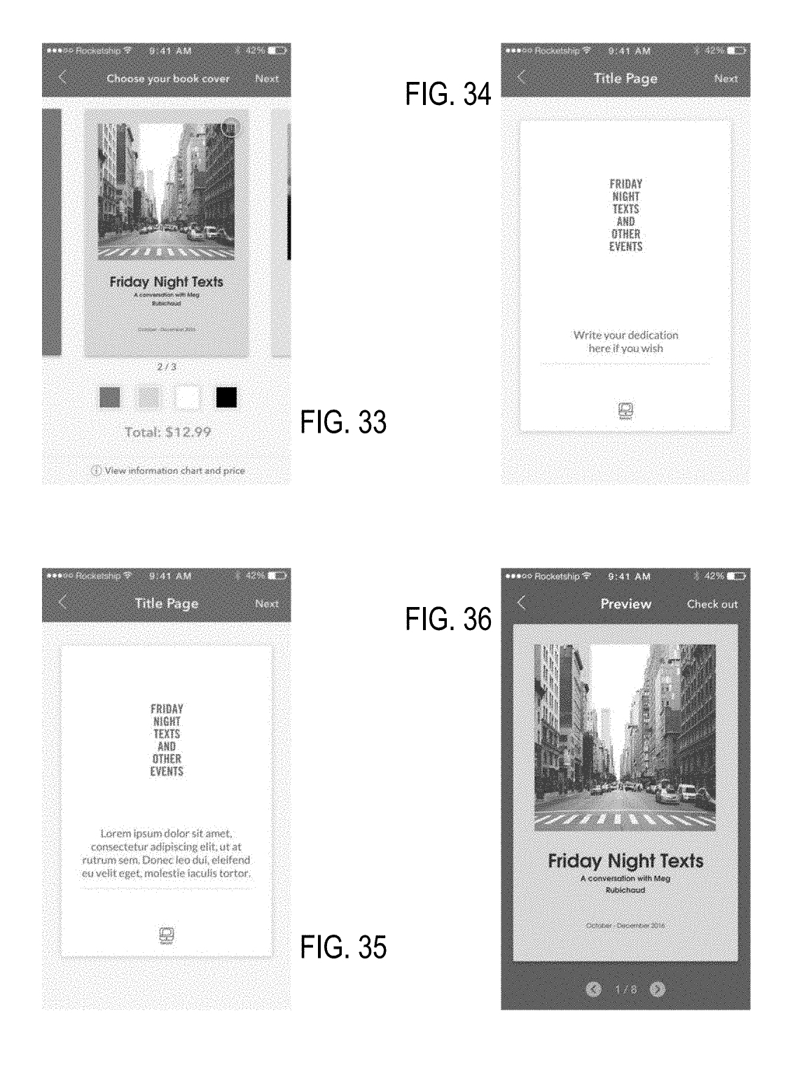

FIG. 2 shows a method to generate a package of selected electronic messages according to one embodiment. For example, the method of FIG. 2 can be implemented in the system of FIG. 1 with one or more user interfaces as illustrated in FIGS. 3-34.

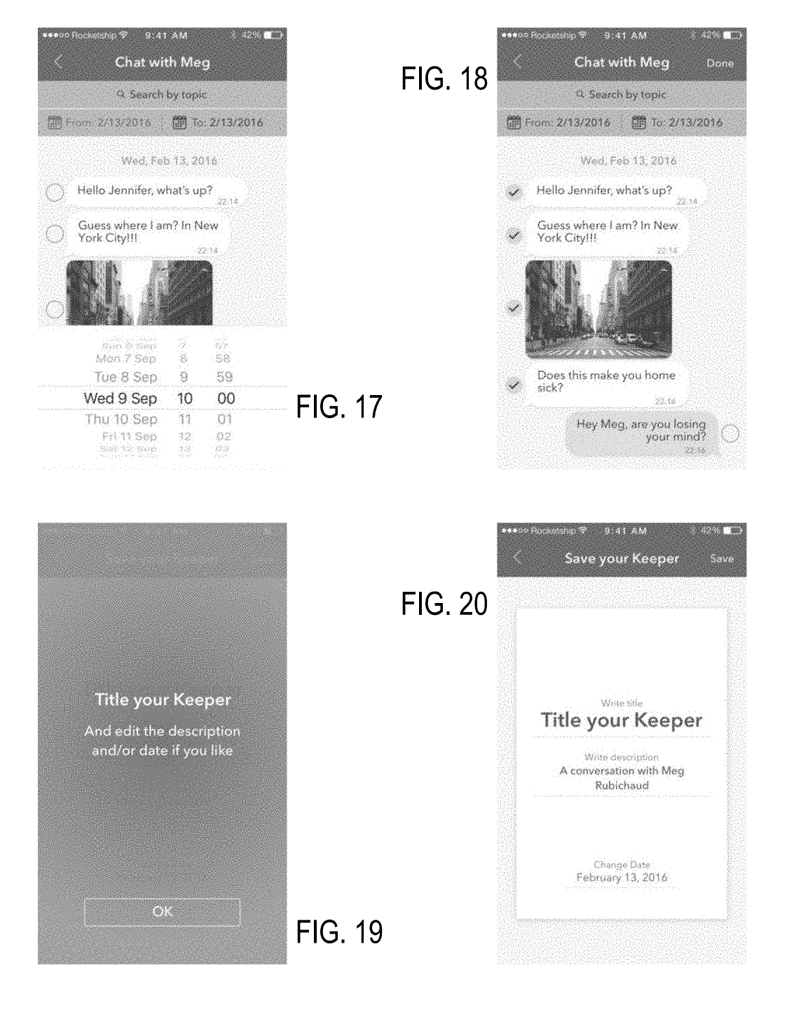

In FIG. 2, a computing apparatus is configured to: provide (161) a mobile application (131) on a mobile device (105) having messaging applications (135) handling messages serviced by respective servers (111) using different communication protocols; retrieve (163) messages from different accounts of the user (101) from the respective servers (111); index (165) the messages for searching; provide (167) a search interface (e.g., illustrated in FIGS. 12-16) in the mobile application (131); receive (169) a search request in the search interface; identify (171) a subset of the messages as a search result that satisfy the requirements of the search request; present (173) a list of the messages in the subset for selection (e.g., as illustrated in FIGS. 17 and 18); and generate (175) a package using messages selected from the list (e.g., illustrated in FIGS. 19-35).

The package can be archived in the mobile device (105), or in a computer (103) of the user (101), and/or in the application server (107).

The package can be created and/or presented by the mobile application (131) as an electronic book, printed as a book with a cover or title page generated using the mobile application (131), and/or shared with friends using one of the messaging applications (135).

The search request may optionally specify the requirements of the search in terms of: keyword, date, sender, and/or receiver.

In some instances, the mobile application (131) communicates the retrieved messages to a separate computer (103) of the user (101), when a communication connection between the computer and the mobile device is established. The mobile application (131) may optionally use the data storage and/or the communication bandwidth of the computer (103) to communicate the retrieved messages to a centralized server (107) (e.g., for indexing and/or for archive).

In some instances, the computer (103) runs an application (123) that obtains the retrieved messages from the mobile application (131) for indexing and storage at the computer (103) and/or the application server (107).

In some instances, the application (123) running in the computer (103) communicates with the centralized application server (107) that is remote from the computer (103) to index and store the retrieved messages.

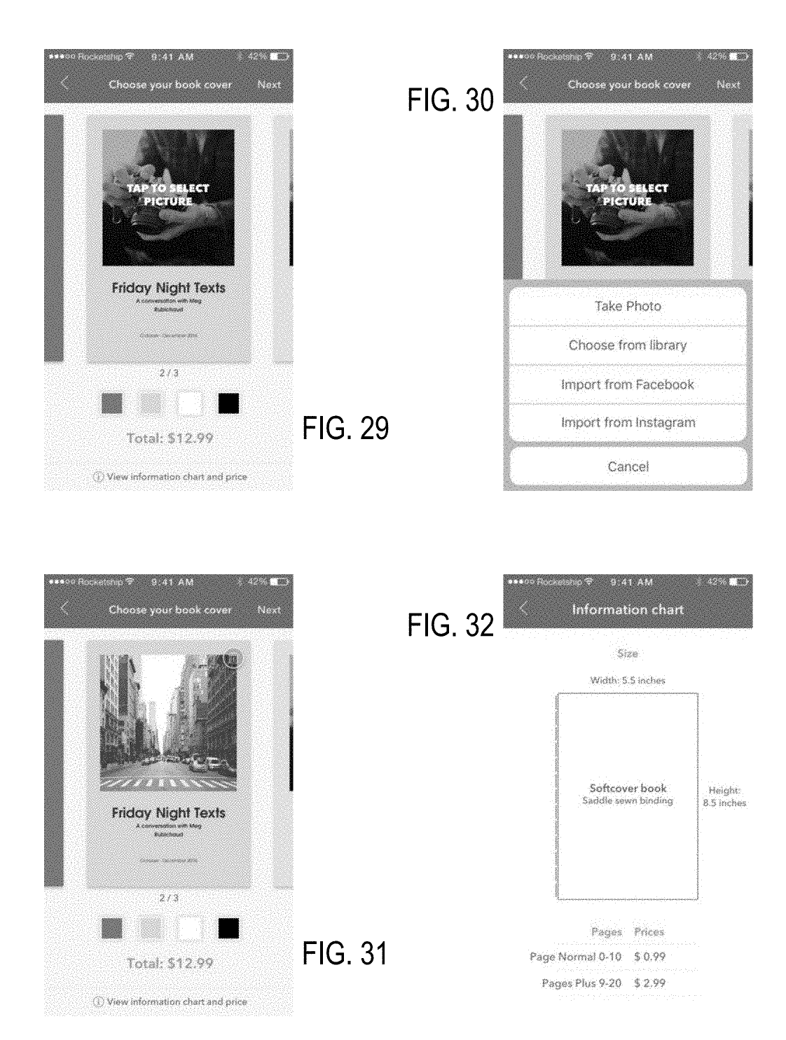

Optionally, the mobile application (131) may provide an interactive user interface to generate a cover or title page of the book. For example, the user interface may receive a title of the book from the user, as illustrated in FIGS. 19-20, and/or obtain a picture for the book cover, as illustrated in FIGS. 29-30.

Optionally, the mobile application (131) may provide a user interface to share the book via one of the plurality of messaging applications, as illustrated in FIGS. 23 and 24.

In some instances, the mobile application (131) establishes a communication from the mobile device (105) to the computer (103) of the user (101) and communicates with the application (123) running in the computer (123) to retrieve at least some of the messages from some of the message servers (111). For example, the application (123) running in the computer (103) may use an internet connection to obtain the retrieved messages from the plurality of messaging servers (111) (e.g., when the computer (103) has a better connection to the internet than the mobile device (105)).

In some instances, the mobile application (131) retrieves at least a portion of the retrieved messages from one or more of the plurality of messaging applications (135) running in the mobile device (105), such as messages handled from a message server (111) that does not store messages that have been delivered to the mobile device (105) and/or messages that have been sent from the mobile device (105) to the intended recipients.

In some instances, the mobile application (131), the application (123) running in the computer (123), and/or the application server (107) retrieves at least a portion of the retrieved messages from at least one of the plurality of message servers (111) using credentials of the user, without going through the plurality of messaging applications (135) running in the mobile application (131).

The created package can be stored separately from the one or more messages selected from the list to create the package and may have a expiration time period different from an expiration time period(s) of the messages based on which the package is created.

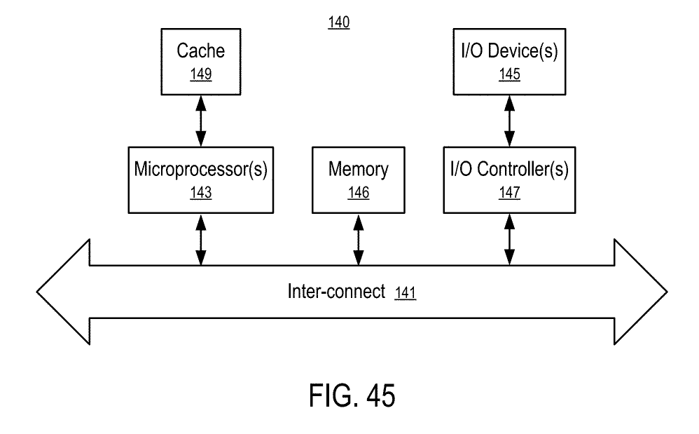

In FIG. 1, the mobile device (105), the computer (103), the application server (107), and/or the message servers (111) can each implemented using one or more data processing systems illustrated in FIG. 45.

FIGS. 3-34 illustrate examples of user interfaces to operate a mobile application according to one embodiment.

FIG. 3 shows a log in screen where the user (101) is prompted to provide credentials to sign into the account of the user (101) in the mobile application (131) and/or the application server (107).

FIG. 4 shows a welcome message of the mobile application (131).

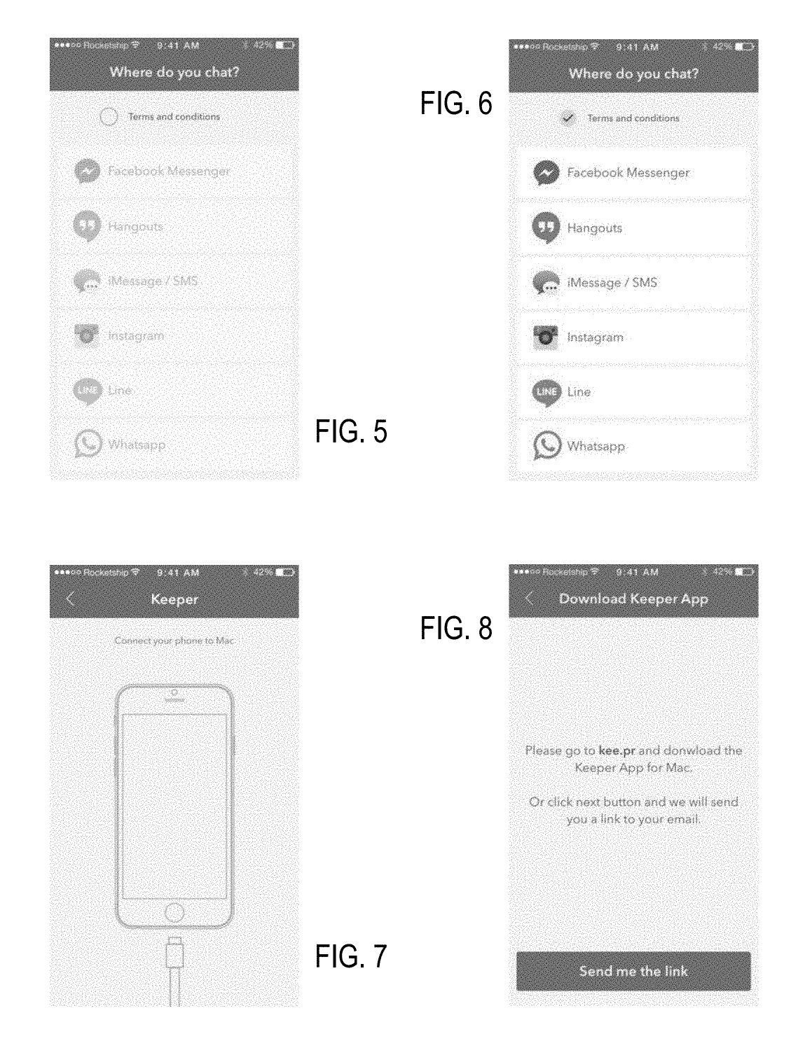

FIGS. 5-6 show a list of messaging applications (105) from which the system is configured to retrieve the messages of the user (101), where the user (101) is prompted to accept the terms and conditions of the services of the mobile application (131) and/or the application server (107).

FIGS. 7-8 illustrate the instructions provided by the mobile application (131) to the user (101) to guide the user (101) through the process of installing the application (123) on the computer (103).

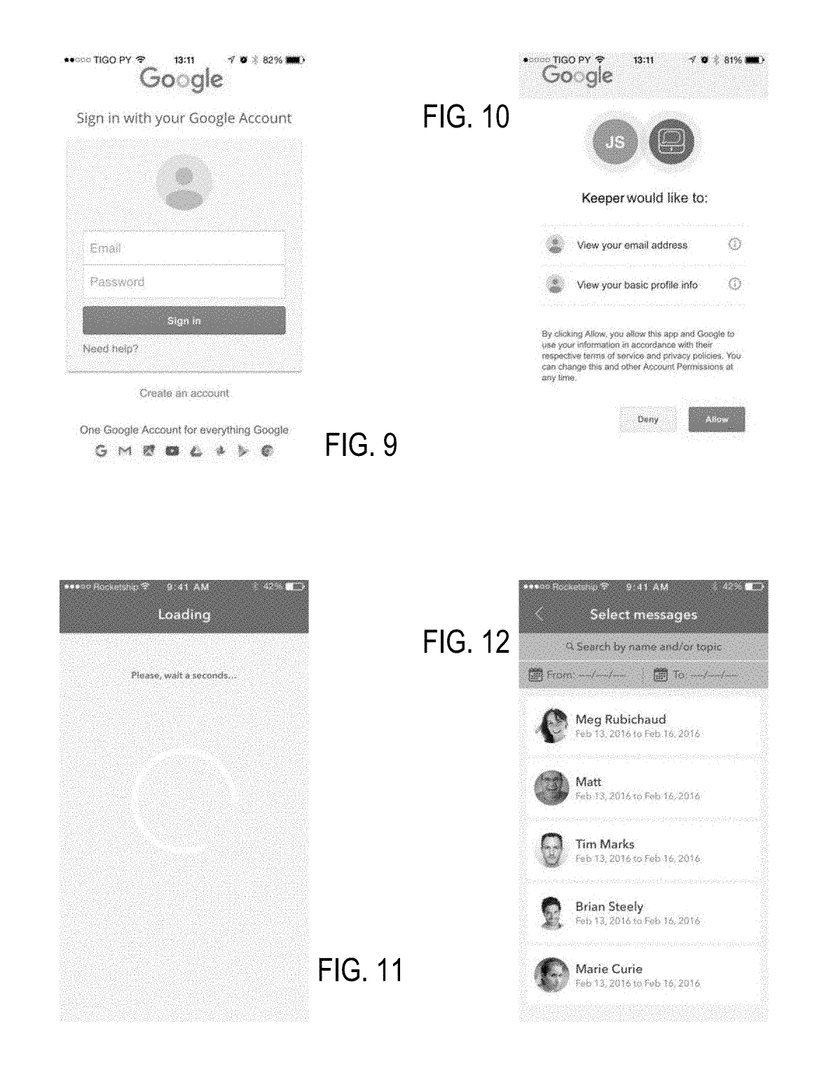

FIGS. 9-11 illustrate the mobile application (131) obtains permission from the user (101) to retrieve messages from one of the message servers (111) (e.g., using XMPP).

FIGS. 12-15 illustrate searches of messages performed using the mobile application (131).

FIGS. 16-18 illustrate the selection of search results to form a package of messages (keeper).

FIGS. 19-22 illustrate the customization of a package (keeper) with title and/or date.

FIG. 23 illustrates options selectable to operation on a package (keeper), such as printing as book, printing as card, sharing using a messaging application (135).

FIG. 24 illustrates the sharing of a package (keeper) using one of a plurality of selectable messaging application (135) (e.g., “Mail”, “Message”).

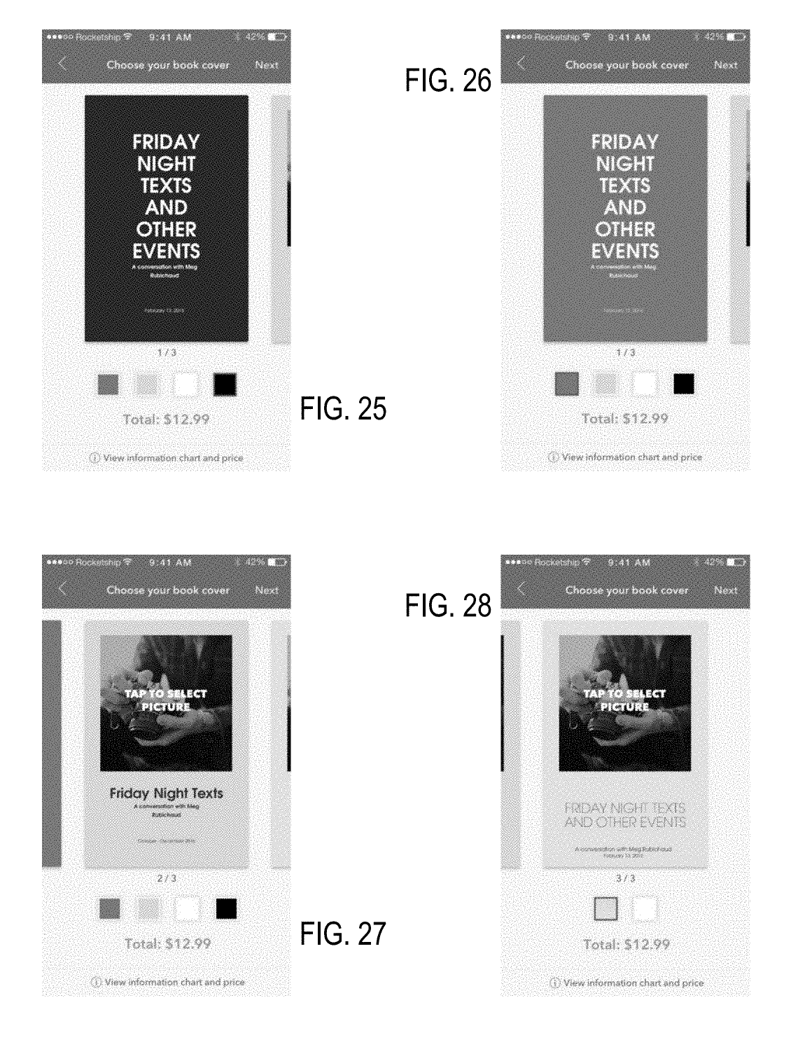

FIGS. 25-35 illustrate the customization process of printing a package (keeper) as a book (e.g., via the application server (107)). The book can be customized with a cover and/or a title page.

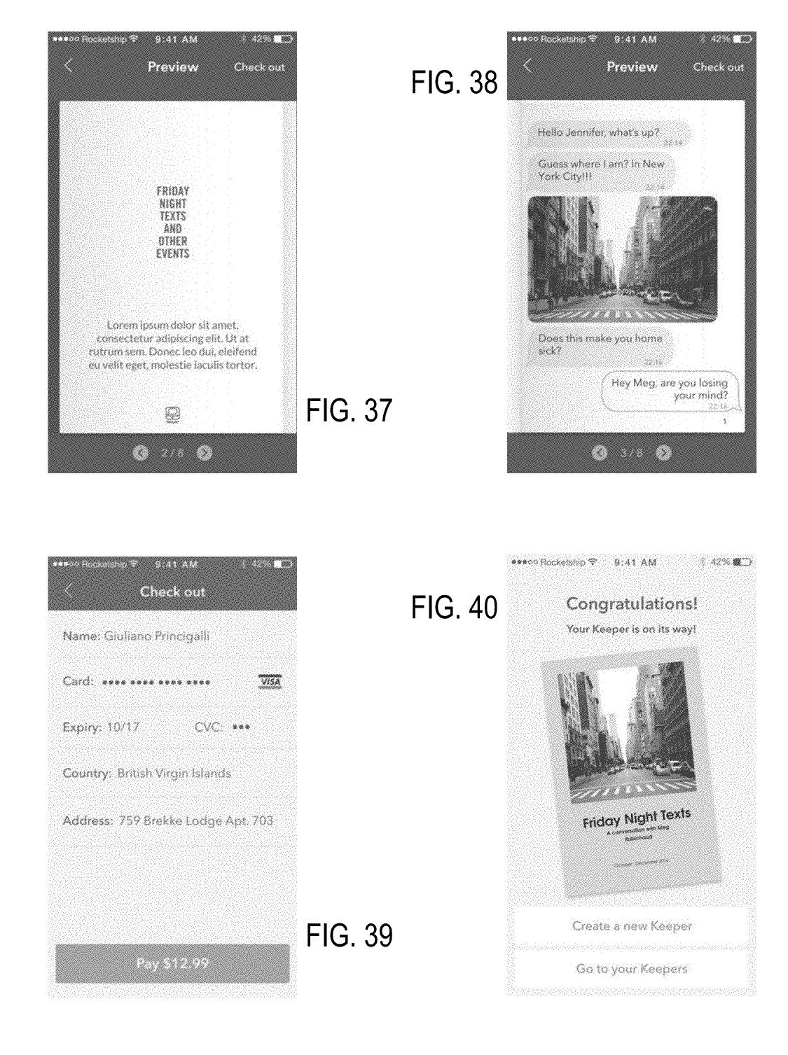

FIGS. 36-38 provides a previous of the book to be printed from a package (keeper).

FIGS. 39-40 illustrate a check out process for printing the book.

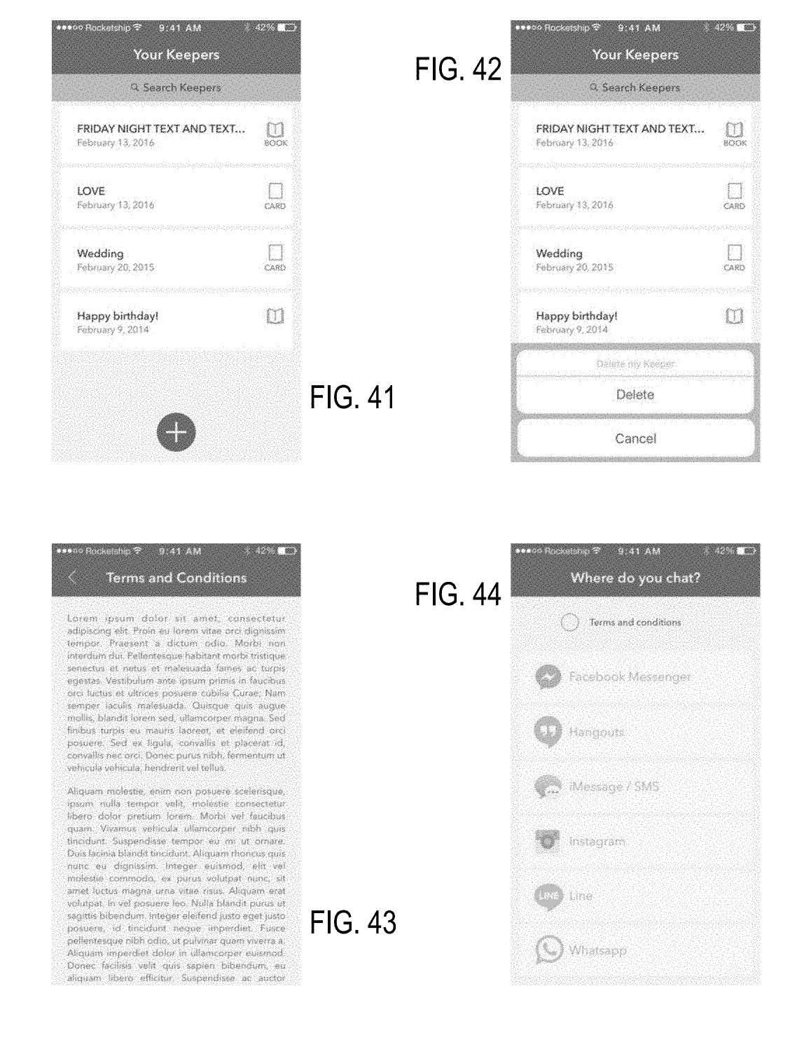

FIGS. 41-42 illustrate the presentation of a list of previously created packages and optional options to delete any of the selected packages.

FIGS. 43 and 44 illustrate the presentation of terms and conditions of the services of the system.

Each of the computer (103), the mobile device (105), the application server (107), and any of the message servers (111) can be implemented using one or more data processing systems, such as a data processing system illustrated in FIG. 45, with or more less components.

FIG. 45 illustrates a data processing system according to one embodiment. While FIG. 45 illustrates various components of a computer system, it is not intended to represent any particular architecture or manner of interconnecting the components. One embodiment may use other systems that have fewer or more components than those shown in FIG. 45.

In FIG. 45, the data processing system (140) includes an inter-connect (141) (e.g., bus and system core logic), which interconnects a microprocessor(s) (143) and memory (146). The microprocessor (143) is coupled to cache memory (149) in the example of FIG. 45.

In one embodiment, the inter-connect (141) interconnects the microprocessor(s) (143) and the memory (146) together and also interconnects them to input/output (I/O) device(s) (145) via I/O controller(s) (147). I/O devices (145) may include a display device and/or peripheral devices, such as mice, keyboards, modems, network interfaces, printers, scanners, video cameras and other devices known in the art. In one embodiment, when the data processing system is a server system, some of the I/O devices (145), such as printers, scanners, mice, and/or keyboards, are optional.

In one embodiment, the inter-connect (141) includes one or more buses connected to one another through various bridges, controllers and/or adapters. In one embodiment the I/O controllers (147) include a USB (Universal Serial Bus) adapter for controlling USB peripherals, and/or an IEEE-1394 bus adapter for controlling IEEE-1394 peripherals.

In one embodiment, the memory (146) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

### Other Aspects

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

The disclosures of the above discussed patent documents are hereby incorporated herein by reference.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method, comprising:
providing a mobile application on a mobile device of a user, wherein the user has a plurality of accounts on a plurality of different servers respectively, and the mobile device has a plurality of messaging applications configured to communicate with the plurality of different servers respectively using different communication protocols to present messages in the accounts of the user;
retrieving, via the mobile application, messages from the different accounts of the user, wherein the retrieved messages are indexed for searching, and the mobile application has a search interface for the retrieved messages;
receiving in the search interface of the mobile application a search request;
identifying, among the retrieved messages that are indexed for searching, a subset of messages that satisfy requirements of the search request;
presenting, by the mobile application, a list of messages in the subset;
in response to the user selecting one or more messages from the list using the mobile application, creating a package that includes the one or more selected messages; and
archiving the package.

2. The method of claim 1, wherein the search request specifies the requirements in one of: keyword, date, sender, and receiver.

3. The method of claim 2, further comprising:
communicating, from the mobile application, the retrieved messages to a computer of the user, when a communication connection between the computer and the mobile device is established.

4. The method of claim 3, wherein the computer runs an application that obtains the retrieved messages from the mobile application for indexing and storage.

5. The method of claim 3, wherein the application running in the computer communicates with a centralized server, remote from the computer to index and store the retrieved messages.

6. The method of claim 3, wherein the package is configured as a book with a title.

7. The method of claim 6, further comprising:
providing, by the mobile application, an interactive user interface to generate a cover of the book.

8. The method of claim 6, further comprising:
providing, by the mobile application, a user interface to share the book via one of the plurality of messaging applications.

9. The method of claim 1, further comprising:
establishing a communication from the mobile device to a computer of the user; and
communicating by the mobile application with an application running in the computer to retrieve the retrieved messages.

10. The method of claim 9, wherein the application running in the computer uses an internet connection to obtain the retrieved messages from the plurality of different servers.

11. The method of claim 1, wherein the mobile application retrieves at least a portion of the retrieved messages from one or more of the plurality of messaging applications running in the mobile device.

12. The method of claim 1, wherein the mobile application retrieves at least a portion of the retrieved messages from at least one of the plurality of different servers using credentials of the user, without going through the plurality of messaging applications running in the mobile application.

13. The method of claim 1, wherein the package is stored separately from the one or more messages selected from the list.

14. The method of claim 13, wherein the package is archived for a time period different from one or more time periods for archiving the one or more messages selected from the list from which the package is created.

15. The method of claim 14, wherein at least one of the plurality of different servers does not store messages that have been delivered to the mobile device.

16. A non-transitory computer readable medium storing instructions of a mobile application which, when executed on a mobile device, cause the mobile device to perform a method, the method comprising:
running the mobile application on the mobile device of a user, wherein the user has a plurality of accounts on a plurality of different servers respectively, and the mobile device has a plurality of messaging applications configured to communicate with the plurality of different servers respectively using different communication protocols to present messages in the accounts of the user;
retrieving, via the mobile application, messages from the different accounts of the user, wherein the retrieved messages are indexed for searching, and the mobile application has a search interface for the retrieved messages;
receiving in the search interface of the mobile application a search request;
identifying, among the retrieved messages that are indexed for searching, a subset of messages that satisfy requirements of the search request;
presenting, by the mobile application, a list of messages in the subset;
in response to the user selecting one or more messages from the list using the mobile application, creating a package based on the one or more selected messages; and
presenting the package as a book.

17. A mobile device, comprising:
at least one microprocessor; and
a memory storing instructions of a mobile application which, when executed on the mobile device, cause the mobile device to:
run the mobile application on a mobile device of a user, wherein the user has a plurality of accounts on a plurality of different servers respectively, and the mobile device has a plurality of messaging applications configured to communicate with the plurality of different servers respectively using different communication protocols to present messages in the accounts of the user;
retrieve, via the mobile application, messages from the different accounts of the user, wherein the retrieved messages are indexed for searching, and the mobile application has a search interface for the retrieved messages;
receive in the search interface of the mobile application a search request;
identify, among the retrieved messages that are indexed for searching, a subset of messages that satisfy requirements of the search request;
present, by the mobile application, a list of messages in the subset;
receive, in the mobile application, a user selection of one or more messages from the list; and
create a book based on the one or more selected messages.

18. The mobile device of claim 17, wherein the mobile application further causes the mobile device to:
provide an interactive user interface to generate a cover of the book.

19. The mobile device of claim 18, wherein the mobile application further causes the mobile device to provide a user interface configured to receive a request to print the book.

20. The mobile device of claim 18, wherein the mobile application further causes the mobile device to provide a user interface configured to select one of the plurality of messaging applications to share the book.
